(19) United States
(12) Patent Application Publication
(10) Pub. No.: US 2026/0289977 A1
(43) Pub. Date: Sep. 24, 2026

(54) TRAINING METHOD FOR OBJECT DETECTION MODEL FOR LOW-QUALITY IMAGE, OBJECT DETECTION METHOD FOR LOW-QUALITY IMAGE, AND RELATED DEVICE

(71) Applicants: SANYA NANHAI INNOVATION AND DEVELOPMENT BASE OF HARBIN ENGINEERING UNIVERSITY, Sanya (CN); HARBIN ENGINEERING UNIVERSITY, Harbin (CN)

(72) Inventors: Kaiheng DAI, Sanya (CN); Yuanhui WANG, Sanya (CN); Chenglong WANG, Sanya (CN); Xiaoyue ZHANG, Sanya (CN); Tianjiao WEI, Sanya (CN)

(73) Assignees: SANYA NANHAI INNOVATION AND DEVELOPMENT BASE OF HARBIN ENGINEERING UNIVERSITY, Sanya (CN); HARBIN ENGINEERING UNIVERSITY, Harbin (CN)

(21) Appl. No.: 19/695,057

(22) Filed: Jun. 2, 2026

Related U.S. Application Data
(63) Continuation of application No. PCT/CN2025/107183, filed on Jul. 4, 2025.

(30) Foreign Application Priority Data
Aug. 7, 2024 (CN) 202411076362.9

(51) Int. Cl. G06V 10/774; G06V 10/82; G06V 10/98

(52) U.S. Cl. CPC G06V 10/774; G06V 10/82; G06V 10/993; G06V 2201/07

(57) ABSTRACT

A training method for an object detection model for a low-quality image, an object detection method for a low-quality image, and a related device are provided. The training method includes: acquiring a low-quality sample image for a target region; inputting the low-quality sample image into a first encoder to obtain an initial feature of the low-quality sample image; inputting the initial feature into a transfer convolutional network, and training the transfer convolutional network to obtain a target convolutional network; obtaining a second target feature for the low-quality sample image; inputting the second target feature into a first detection head, and training the first detection head to obtain an object detection head; and obtaining an object detection model, where the object detection model is used for performing object detection on a low-quality image to be subjected to detection.

### CROSS REFERENCE TO THE RELATED APPLICATIONS

This application is a continuation application of International Application No. PCT/CN2025/107183, filed on Jul. 4, 2025, which is based upon and claims priority to Chinese Patent Application No. 202411076362.9, filed on Aug. 7, 2024, the entire contents of which are incorporated herein by reference.

### TECHNICAL FIELD

The present disclosure relates to the technical field of data processing, in particular to a training method for an object detection model for a low-quality image, an object detection method for a low-quality image, and a related device.

### BACKGROUND

In scenarios such as offshore operation scenarios, a visual object detection technology may provide a lot of assistance for making operation decisions. However, in scenarios such as offshore operation scenarios, the quality of captured images often fails to reach standards due to adverse weather conditions, complex sea conditions, and other problems, and thus, lower accuracy and efficiency of object detection are caused. Therefore, how to realize efficient object detection has become an urgent technical problem to be solved.

### SUMMARY

The present disclosure provides a training method for an object detection model for a low-quality image, an object detection method for a low-quality image, and a related device to at least solve the above technical problems existing in the prior art.

The present disclosure provides a training method for an object detection model for a low-quality image, wherein the method includes:
acquiring a low-quality sample image for a target region;
inputting the low-quality sample image into a first encoder to obtain an initial feature of the low-quality sample image;
inputting the initial feature into a transfer convolutional network, and training the transfer convolutional network to obtain a target convolutional network based on a first target feature, wherein the first target feature is obtained based on the initial feature of the low-quality sample image, and a feature definition of the first target feature is higher than a feature definition of the initial feature;
obtaining a second target feature for the low-quality sample image based on the target convolutional network;
inputting the second target feature into a first detection head, and training the first detection head to obtain an object detection head, wherein the first detection head is obtained based on the first target feature; and
obtaining an object detection model based on the first encoder, the target convolutional network and the object detection head, wherein the object detection model is used for performing object detection on a low-quality image to be detected.

In the above-mentioned solution, the inputting the initial feature into a transfer convolutional network, and training the transfer convolutional network to obtain a target convolutional network based on a first target feature, includes:
inputting the initial feature into the transfer convolutional network, and training the transfer convolutional network by using the first target feature as a feature constraint for an output of the transfer convolutional network to obtain the target convolutional network.

In the above-mentioned solution, obtaining the first target feature based on the initial feature of the low-quality sample image, includes:
inputting the initial feature of the low-quality sample image into a pre-trained image type prediction model to obtain a low-quality type of the low-quality sample image; and
obtaining the first target feature for the low-quality sample image based on the low-quality type of the low-quality sample image.

In the above-mentioned solution, the obtaining the first target feature for the low-quality sample image based on the low-quality type of the low-quality sample image, includes:
inputting the low-quality type of the low-quality sample image into a pre-trained content mapping network to obtain mapping encoding information for the low-quality type;
inputting the mapping encoding information and the initial feature of the low-quality sample image into a first decoder to obtain a restored sample image, wherein a definition of the restored sample image is higher than a definition of the low-quality sample image; and
obtaining the first target feature for the low-quality sample image based on the restored sample image.

In the above-mentioned solution, the obtaining the first target feature for the low-quality sample image based on the restored sample image, includes:
inputting the restored sample image and the low-quality sample image into a second encoder to obtain the first target feature;
obtaining the first detection head based on the first target feature, includes:
inputting the first target feature into a second detection head to be trained, and training the second detection head to be trained to obtain the first detection head.

The present disclosure provides an object detection method for a low-quality image, wherein the method includes:
acquiring a low-quality image to be detected for a region to be detected; and
inputting the low-quality image to be detected into an object detection model to obtain an object detection result for the region to be detected; wherein the object detection result is obtained by extracting a feature of the low-quality image to be detected by a first encoder in the object detection model, transferring the feature, which is extracted, by a target convolutional network in the object detection model, and performing object detection based on the feature, which is transferred, by an object detection head in the object detection model, and the object detection result is used for characterizing whether there is a target object in the region to be detected.

The present disclosure provides a training apparatus for an object detection model for a low-quality image, wherein the apparatus includes:
a first acquisition unit, used for acquiring a low-quality sample image for a target region;
a second acquisition unit, used for inputting the low-quality sample image into a first encoder to obtain an initial feature of the low-quality sample image;
a third acquisition unit, used for inputting the initial feature into a transfer convolutional network, and training the transfer convolutional network to obtain a target convolutional network based on a first target feature, wherein the first target feature is obtained based on the initial feature of the low-quality sample image, and a feature definition of the first target feature is higher than a feature definition of the initial feature;
a fourth acquisition unit, used for obtaining a second target feature for the low-quality sample image based on the target convolutional network;
a fifth acquisition unit, used for inputting the second target feature into a first detection head, and training the first detection head to obtain an object detection head, wherein the first detection head is obtained based on the first target feature; and
a sixth acquisition unit, used for obtaining an object detection model based on the first encoder, the target convolutional network and the object detection head, wherein the object detection model is used for performing object detection on a low-quality image to be detected.

The present disclosure provides an object detection apparatus for a low-quality image, wherein the apparatus includes:
a seventh acquisition unit, used for acquiring a low-quality image to be detected for a region to be detected; and
a detection unit, used for inputting the low-quality image to be detected into an object detection model to obtain an object detection result for the region to be detected; wherein the object detection result is obtained by extracting a feature of the low-quality image to be detected by a first encoder in the object detection model, transferring the feature, which is extracted, by a target convolutional network in the object detection model, and performing object detection based on the feature, which is transferred, by an object detection head in the object detection model, and the object detection result is used for characterizing whether there is a target object in the region to be detected.

The present disclosure provides an electronic device, including:
at least one processor; and
a memory connected in communication with the at least one processor; wherein
the memory stores instructions executed by the at least one processor, and the instructions, upon being executed by the at least one processor, causes the at least one processor to perform the method in the present disclosure.

The present disclosure provides a non-transitory computer-readable storage medium having computer instructions stored thereon, wherein the computer instructions are used for enabling a computer to perform the method in the present disclosure.

In the present disclosure, a low-quality sample image for a target region is acquired; the low-quality sample image is inputted into a first encoder to obtain an initial feature of the low-quality sample image; the initial feature is inputted into a transfer convolutional network, and based on a first target feature, the transfer convolutional network is trained to obtain a target convolutional network, wherein the first target feature is obtained based on the initial feature of the low-quality sample image, and the feature definition of the first target feature is higher than the feature definition of the initial feature; based on the target convolutional network, a second target feature for the low-quality sample image is obtained; the second target feature is inputted into a first detection head, and the first detection head is trained to obtain an object detection head, wherein the first detection head is obtained based on the first target feature; and based on the first encoder, the target convolutional network and the object detection head, an object detection model is obtained, wherein the object detection model is used for performing object detection on a low-quality image to be detected. Efficient object detection may be realized.

It should be understood that the content described in this section is not intended to identify key or important features in embodiments of the present disclosure or limit the scope of the present disclosure. Other features of the present disclosure will be easily understood through the following description.

### BRIEF DESCRIPTION OF THE DRAWINGS

By reading the detailed description below with reference to the drawings, the above-mentioned and other objects, features and advantages of exemplary implementations of the present disclosure will be easy to understand. In the drawings, a plurality of embodiments of the present disclosure are illustrated by way of examples rather than limitations, wherein:

in the drawings, the same or corresponding reference numerals indicate the same or corresponding parts.

FIG. 1 shows a schematic diagram of a realization process of a training method for an object detection model for a low-quality image in an embodiment of the present disclosure;

FIG. 2 shows a schematic diagram of an acquisition process of a target convolutional network in an embodiment of the present disclosure;

FIG. 3 shows a schematic diagram of an acquisition process of a first detection head in an embodiment of the present disclosure;

FIG. 4 shows a schematic diagram of a structure of an image type prediction model in an embodiment of the present disclosure;

FIG. 5 shows a schematic diagram of a processing process of a content mapping network in an embodiment of the present disclosure;

FIG. 6 shows a schematic diagram of structural comparison between an object detection head and a first detection head in an embodiment of the present disclosure;

FIG. 7 shows a schematic diagram of a realization process of an object detection method for a low-quality image in an embodiment of the present disclosure;

FIG. 8 shows a schematic diagram of a structure of an object detection model in an embodiment of the present disclosure;

FIG. 9 shows a schematic diagram of a structure of a training apparatus for an object detection model for a low-quality image in an embodiment of the present disclosure;

FIG. 10 shows a schematic diagram of a structure of an object detection apparatus for a low-quality image in an embodiment of the present disclosure; and

FIG. 11 shows a schematic diagram of a structure of an electronic device in an embodiment of the present disclosure.

### DETAILED DESCRIPTION OF THE EMBODIMENTS

In order to make the objects, features and advantages of the present disclosure more apparent and understandable, the technical solutions in the embodiments of the present disclosure will be described clearly and completely below in conjunction with the drawings in the embodiments of the present disclosure. Apparently, the described embodiments are only a part of the embodiments of the present disclosure, not all the embodiments. Based on the embodiments in the present disclosure, all other embodiments obtained without creative work by those skilled in the art shall fall within the protective scope of the present disclosure.

In the embodiments of the present disclosure, a low-quality image refers to a distorted image with the definition lower than a preset (or standard) threshold, which results in incapability of performing (accurately) object detection on the image. A low-quality sample image and a low-quality image to be detected mentioned in the embodiments of the present disclosure are both the distorted image with the definition lower than the preset (or standard) threshold.

The technical solutions in the embodiments of the present disclosure involve a solution for training an object detection model for a low-quality image and a solution for performing object detection on the obtained low-quality image to be detected by using the trained object detection model. According to the technical solutions of the present disclosure, the object detection model may be efficiently acquired, and thus, efficient object detection is realized.

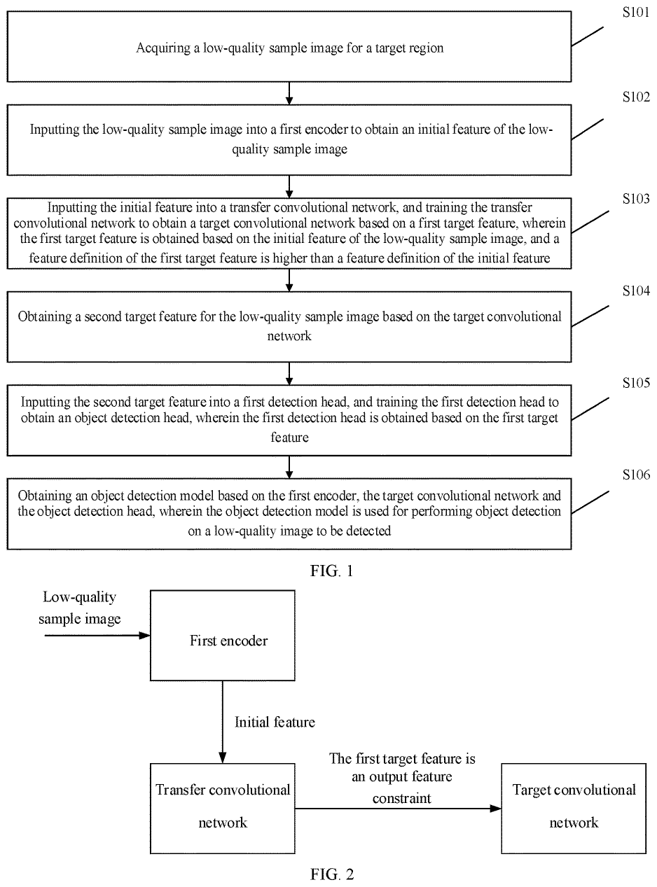

An embodiment of the present disclosure provides a training method for an object detection model for a low-quality image, as shown in FIG. 1, the method includes:

S101: acquiring a low-quality sample image for a target region.

In this step, the target region is a region where a known target object is located, and the low-quality sample image refers to an image with a relatively poor image quality (for example, a relatively low definition), that is, the low-quality sample image is a low-quality image that includes the target object.

In offshore operation scenarios, due to common high-humidity conditions such as fog and rain at sea, or problems such as rapid movement of vessels, harsh sea conditions, complex water surface reflection, cluttered environments, and strong interference from dynamic backgrounds, an image captured for the target region is a low-quality image.

S102: inputting the low-quality sample image into a first encoder to obtain an initial feature of the low-quality sample image.

In this step, the first encoder is used for image restoration. Through the image restoration, the low-quality sample image may be restored to a relatively clear image, and thus, the accuracy of subsequently training the object detection model is improved.

The low-quality sample image is inputted into the first encoder, and the first encoder may perform a feature extraction for the low-quality sample image to obtain the initial feature of the low-quality sample image. The first encoder may adopt a convolutional module, a residual module, or a Swin Transformer (Shifted Window Multi-level Vision Model) module, etc., and usually adopts a layer-by-layer down-sampling method to collect 3-4 scale convolutional features from the feature of the image (low-quality sample image) so as to select deep semantic information of the image. A specific application of the first encoder is described in detail with reference to the following relevant section and is no longer repeated herein.

S103: inputting the initial feature into a transfer convolutional network, and training the transfer convolutional network to obtain a target convolutional network based on a first target feature, wherein the first target feature is obtained based on the initial feature of the low-quality sample image, and a feature definition of the first target feature is higher than a feature definition of the initial feature.

In this step, the first target feature is acquired in advance and may be used for object detection, the first target feature is obtained based on the initial feature of the low-quality sample image, and the feature definition of the first target feature is higher than the feature definition of the initial feature. The process of obtaining the first target feature is described in detail with reference to the following relevant section and is no longer repeated herein.

After the initial feature of the low-quality sample image is obtained in S102, the initial feature is inputted into the transfer convolutional network (a convolutional network to be trained), and based on the first target feature, the transfer convolutional network is trained to obtain a trained convolutional network, i.e., the target convolutional network. The target convolutional network is used for feature transfer, i.e., the initial feature of the low-quality sample image is transferred to a feature that may be used for object detection (i.e., a second target feature mentioned below).

S104: obtaining a second target feature for the low-quality sample image based on the target convolutional network.

In this step, based on the trained target convolutional network, the initial feature may be directly transferred to the feature that may be used for object detection, i.e., the second target feature. A feature definition of the second target feature is higher than the feature definition of the initial feature. Moreover, the second target feature is obtained through the target convolutional network trained based on the first target feature. Considering that deep learning training cannot achieve absolute accuracy, the feature definition of the second target feature is less than or equal to the feature definition of the first target feature. The reason for transferring the initial feature by using the target convolutional network is that, compared with a solution that a plurality of models are adopted for serial processing to obtain the feature used for object detection, the solution that the trained target convolutional network is directly adopted to transfer the initial feature to obtain the feature for object detection may greatly reduce the computation of data and shorten the processing time, thereby realizing lightweight object detection and increasing the efficiency of object detection while ensuring the accuracy of object detection.

S105: inputting the second target feature into a first detection head, and training the first detection head to obtain an object detection head, wherein the first detection head is obtained based on the first target feature.

In this step, the first detection head is obtained in advance based on the first target feature, and is used for performing object detection. After the feature used for object detection, i.e., the second target feature, is obtained, in order to ensure that the first detection head may better adapt to the second target feature to realize training consistency between the target convolutional network and the first detection head, the second target feature is inputted into the first detection head for training to obtain the object detection head.

S106: obtaining an object detection model based on the first encoder, the target convolutional network and the object detection head, wherein the object detection model is used for performing object detection on a low-quality image to be detected.

In this step, the first encoder forms the object detection model together with the target convolutional network and the object detection head obtained through the aforementioned steps. This object detection model may be applied to object detection of the low-quality image to be detected in practical scenarios.

In the solutions shown in S101 to S106, the low-quality sample image for the target region is acquired; the low-quality sample image is inputted into the first encoder to obtain the initial feature of the low-quality sample image; the initial feature is inputted into the transfer convolutional network, and based on the first target feature, the transfer convolutional network is trained to obtain the target convolutional network, and the first target feature is obtained based on the initial feature of the low-quality sample image, and the feature definition of the first target feature is higher than the feature definition of the initial feature; based on the target convolutional network, the second target feature for the low-quality sample image is obtained; the second target feature is inputted into the first detection head, and the first detection head is trained to obtain the object detection head, and the first detection head is obtained based on the first target feature; and based on the first encoder, the target convolutional network and the object detection head, the object detection model is obtained, and the object detection model is used for performing object detection on the low-quality image to be detected. Efficient object detection can be realized.

In an optional solution, in S103: the inputting the initial feature into a transfer convolutional network, and training the transfer convolutional network to obtain a target convolutional network based on a first target feature, includes:
inputting the initial feature into the transfer convolutional network, and training the transfer convolutional network by using the first target feature as a feature constraint for an output of the transfer convolutional network to obtain the target convolutional network.

In the present disclosure, as shown in FIG. 2, the initial feature obtained from the low-quality sample image through the first encoder is inputted into the transfer convolutional network, and the transfer convolutional network is trained by using the first target feature as the feature constraint for the output of the transfer convolutional network to obtain the target convolutional network. The initial feature is extracted by the first encoder and used for image restoration, while the first target feature is used for object detection. Due to a domain difference between the initial feature and the first target feature, the initial feature cannot be directly used for object detection. Therefore, the initial feature needs to be transferred before object detection. Specifically, the initial feature is inputted into the transfer convolutional network, and the transfer convolutional network is trained by using the first target feature as the feature constraint for the output of the transfer convolutional network. A loss function of the transfer convolutional network is shown in formula (1) to formula (4):

$$L = {L}_{p} ( {f}_{u} , {k}_{u} ) + {L}_{r} ( {f}_{u} , {k}_{u} ) + {L}_{t} ( {f}_{u} , {k}_{u} ) \qquad formula ( 1 )$$

$$Wherein ,$$

$${L}_{p} ( {f}_{u} , {k}_{u} ) = {\sum }_{c = 1}^{c} {\sum }_{w = 1}^{w} {\sum }_{h = 1}^{h} {‖ {f}_{u , c , w , h} - {k}_{u , c , w , h} ‖}^{2} \qquad formula ( 2 )$$

$${L}_{r} ( {f}_{u} , {k}_{u} ) = {\sum }_{c = 1}^{c} {‖ {\sum }_{w = 1}^{w} {\sum }_{h = 1}^{h} {f}_{u , c , w , h} - {\sum }_{w = 1}^{w} {\sum }_{h = 1}^{h} {k}_{u , c , w , h} ‖}^{2} \qquad formula ( 3 )$$

$${L}_{t} ( {f}_{u} , {k}_{u} ) = {\sum }_{w = 1}^{w} {\sum }_{h = 1}^{h} {‖ {\sum }_{c = 1}^{c} {f}_{u , c , w , h} - {\sum }_{c = 1}^{c} {k}_{u , c , w , h} ‖}^{2} \qquad formula ( 4 )$$

wherein in formula (1) to formula (4), L represents a loss function value of the transfer convolutional network; f represents the initial feature, and k represents the first target feature; u represents the number of features; Lₚ(fᵤ,kᵤ) represents a point-to-point feature difference between the initial feature and the first target feature; Lᵣ(fᵤ,kᵤ) represents a region-to-region feature difference between the initial feature and the first target feature; Lₜ(fᵤ, kᵤ) represents a channel-to-channel feature difference between the initial feature and the first target feature; c, h and w represent three dimensions of the feature, c represents the number of channels of the feature, h represents a height of the feature, and w represents a width of the feature; f_{u,c,w,h} represents the initial feature composed of u features when the number of the channel is c, the height of the feature is h, and the width of the feature is w; k_{u,c,w,h} represents the first target feature composed of u features when the number of the channels is c, the height of the feature is h, and the width of the feature is w.

When the loss of the transfer convolutional network is minimized, that is, when the value of L in aforementioned formula (1) is minimized, the training of the transfer convolutional network is ended to obtain the trained target convolutional network. The target convolutional network may directly transfer the initial feature of the extracted low-quality (sample) image to the feature that can be used for object detection, thereby realizing the lightweight design of the model without affecting the accuracy of the model.

In an optional solution, the obtaining the above-mentioned first target feature based on the initial feature of the low-quality sample image, includes:
inputting the initial feature of the low-quality sample image into a pre-trained image type prediction model to obtain a low-quality type of the low-quality sample image; and
obtaining the first target feature for the low-quality sample image based on the low-quality type of the low-quality sample image.

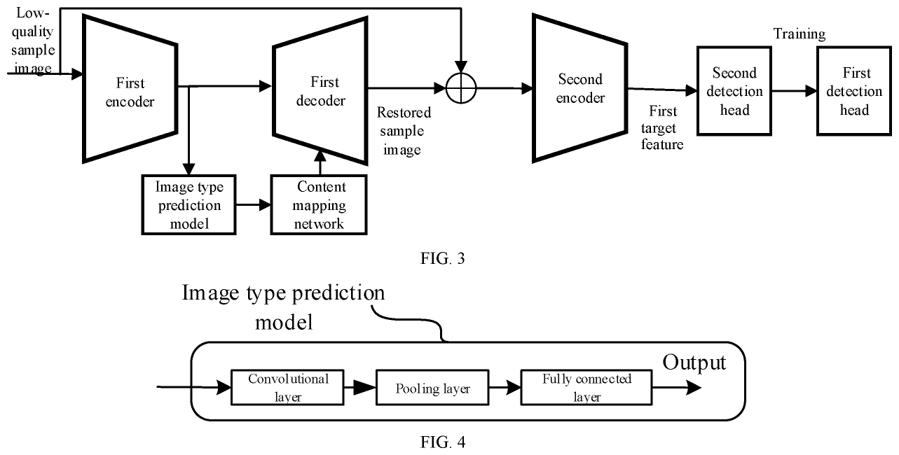

In the present disclosure, as shown in FIG. 3, the initial feature obtained from the low-quality sample image through the first encoder is inputted into the image type prediction model. The image type prediction model is pre-trained and used for predicting the low-quality type of the low-quality sample image. The image type prediction model is trained by learning features of different low-quality types of images in advance. A structure of the image type prediction model, as shown in FIG. 4, includes a convolutional layer, a pooling layer, and a fully connected layer. The convolutional layer and the pooling layer are used for extracting the feature, and the fully connected layer is used for outputting the low-quality type (i.e., a reason for low quality of an image). Exemplarily, in offshore operation scenarios, low-quality types outputted by the fully connected layer include fog, rain, motion blur, sea clutter, and other categories, and the fully connected layer is used for analyzing what types of adverse conditions the current (the low-quality sample) image has experienced, so as to use the types of adverse conditions as a high-level semantic prior to guide the first decoder (described with reference to the following relevant section) to complete clear image reconstruction (the restoration) on the encoded feature (the initial feature). The same low-quality sample image may have one or more low-quality types. Exemplarily, it is assumed that there is a low-quality sample image A, an initial feature of the image A is inputted into an image type prediction model, and thus, a low-quality type (and a probability thereof) of the image A may be obtained. Reasons for the low quality of the image A include: sea wave jitter (20%) and water surface reflection (80%). Based on the low-quality type of the low-quality sample image, the first target feature for the low-quality sample image may be obtained. A specific process of obtaining the first target feature is described in detail with reference to the following relevant section and is no longer repeated herein.

By predicting the low-quality type of the low-quality sample image, a data foundation is provided for subsequent targeted restoration of the low-quality sample image into a clear image, and technical support is provided for realizing accurate object detection.

In an optional solution, the step of obtaining the first target feature for the low-quality sample image based on the low-quality type of the low-quality sample image, includes:
inputting the low-quality type of the low-quality sample image into a pre-trained content mapping network to obtain mapping encoding information for the low-quality type;
inputting the mapping encoding information and the initial feature of the low-quality sample image into a first decoder to obtain a restored sample image, wherein a definition of the restored sample image is higher than a definition of the low-quality sample image; and
obtaining the first target feature for the low-quality sample image based on the restored sample image.

In the present disclosure, as shown in FIG. 3, an output (the low-quality type) of the image type prediction model is used as an input of the content mapping network, and an output of the content mapping network (mapping encoding information) is used as an input of the first decoder.

A structure of the content mapping network is shown in FIG. 5. The content mapping network uses the output of the image type prediction model as an input to expand a low-quality cause probability (a probability that each low-quality type causes image low-quality, such as the above-mentioned 80% and 20%) thereof into a two-dimensional tensor with the same scale as a corresponding feature map, next, two different convolutions are respectively performed after one unified convolution operation to respectively generate y and β with the same number of channels and size as a processed feature (a feature with the low-quality type), y is multiplied by the processed feature, and then, β is added. It is equivalent to separately performing a regularization on each pixel point of each channel of the feature with the low-quality type, thereby obtaining prior information by fusion, performing the feature encoding on the prior information, and embedding the prior information into a feature space of a first decoding layer to perform feature transformation computation.

The first decoder has the same structure as the first encoder, and may also adopt a convolutional module, a residual module, a Swin Transformer module, etc. A difference lies in that the first decoder adopts a layer-by-layer up-sampling method to gradually reconstruct the feature extracted by the first encoder to a spatial resolution of the low-quality sample image, and finally outputs a clear image (restored sample image) with the same spatial and channel sizes as the low-quality sample image. It can be understood that the first decoder is used for image restoration.

The pre-trained content mapping network is used for transforming the output of the image type prediction model into an input that may be recognized by the first decoder, i.e., transforming the low-quality type of the low-quality sample image into the mapping encoding information that may be recognized by the first decoder. The mapping encoding information and the initial feature of the low-quality sample image are jointly used as the input of the first decoder, and the first decoder performs targeted feature reconstruction on the initial feature based on the mapping encoding information to obtain the restored sample image (clear image). A data foundation is provided for realizing accurate object detection. The first target feature of the low-quality sample image is obtained based on the restored sample image, and a specific process is described in detail with reference to the following relevant section.

In an optional solution, the step of obtaining the first target feature for the low-quality sample image based on the restored sample image, includes: inputting the restored sample image and the low-quality sample image into a second encoder to obtain the first target feature.

In the present disclosure, the second encoder is used for object detection. As shown in FIG. 3, the restored sample image and the low-quality sample image are inputted together into the second encoder, and are subjected to feature extraction by the second encoder, which may further ensure the accuracy of feature extraction of the second encoder and obtain the relatively clear and accurate first target feature.

In an optional solution, the obtaining the first detection head based on the first target feature, includes: inputting the first target feature into a second detection head to be trained, and the second detection head to be trained is trained to obtain the first detection head.

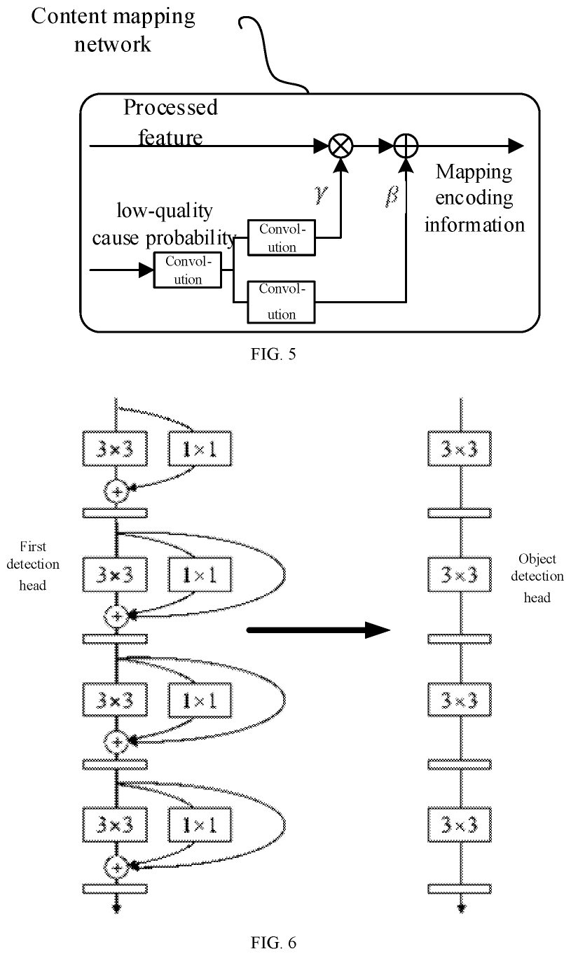

The trained first detection head may perform object detection. As shown in FIG. 6, the object detection head is obtained by training the first detection head and is a structure derived from equivalently merging convolutional modules of the first detection head. It can be understood that a 1×1 convolution is equivalent to a special 3×3 convolution (there are a plurality of zeros in a convolution kernel), and an identity mapping is a special 1×1 convolution (with an identity matrix as a convolution kernel) so as to be also regarded as a special 3×3 convolution. Therefore, the 1×1 convolution in the first detection head is equivalently transformed into the 3×3 convolution, and some of feature space computations are merged by adopting a mathematical merging operation. The capacity and effective feature space of the object detection head may be improved, and when the object detection head is used for object detection, forward computation operations may be reduced, and the computational efficiency of object detection may be increased. It should be noted that FIG. 6 only shows a schematic diagram of a structure of an object detection head, and the object detection head in the embodiments of the present disclosure is not limited to the structure shown in FIG. 6, and is not specifically limited in the present disclosure.

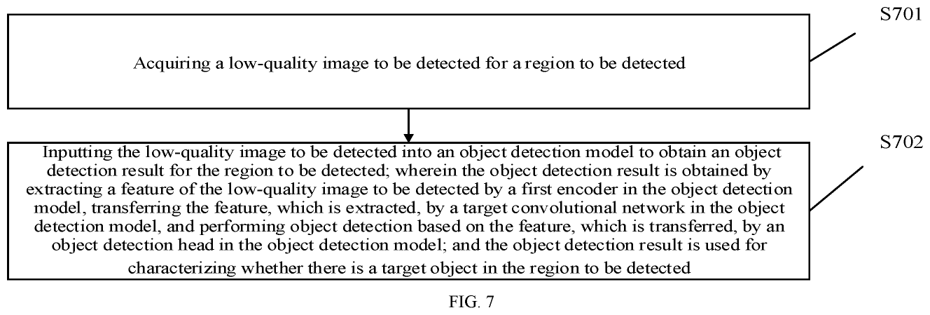

An embodiment of the present disclosure provides an application method of an object detection model for a low-quality image (i.e., an object detection method for a low-quality image), as shown in FIG. 7, the method includes:

S701: acquiring a low-quality image to be detected for a region to be detected.

In this step, the region to be detected is a region to be subjected to object detection, may or may not include the target object. The low-quality image to be detected has relatively low image quality (relatively low definition). For example, in offshore operation scenarios, the low-quality image to be detected may refer to a low-quality image captured from the region to be detected due to common high-humidity conditions such as fog and rain at sea, or problems such as rapid movement of vessels, harsh sea conditions, complex water surface reflection, cluttered environments, and strong interference from dynamic backgrounds.

S702: inputting the low-quality image to be detected into an object detection model to obtain an object detection result for the region to be detected; wherein the object detection result is obtained by extracting a feature of the low-quality image to be detected by a first encoder in the object detection model, transferring the feature, which is extracted, by a target convolutional network in the object detection model, and performing object detection based on the feature, which is transferred, by an object detection head in the object detection model; and the object detection result is used for characterizing whether there is a target object in the region to be detected.

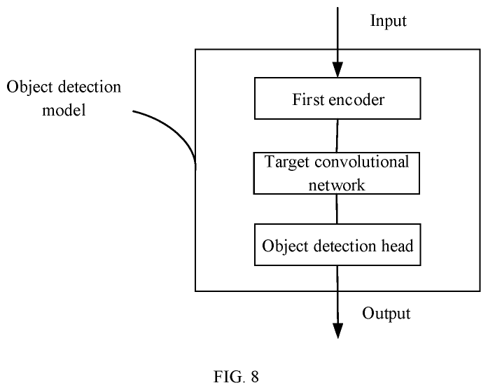

In this step, the low-quality image to be detected is inputted into the object detection model shown in FIG. 8 to obtain the object detection result for the region to be detected, and the object detection result may characterize whether there is the target object in the region to be detected and position information of the target object under the condition that there is the target object. In offshore operation scenarios, the target object may be an obstacle such as a reef. By detecting whether there is a reef in the region to be detected and position information of the reef, an offshore operation vessel may avoid an obstacle in time or make other decisions (such as returning to the port) in response to the obstacle. Specifically, the object detection result is obtained by extracting the feature of the low-quality image to be detected by the first encoder in the object detection model, transferring the extracted feature by the target convolutional network in the object detection model, and performing object detection based on the transferred feature by the object detection head in the object detection model. A specific process of obtaining the first encoder, the target convolutional network and the object detection head is described with reference to the above-mentioned relevant section and is no longer repeated herein.

The solutions shown in S701 to S702 may be regarded as application solutions of the object detection model for the low-quality image. The object detection model obtained according to the solutions shown in aforementioned S101 to S106 may perform object detection for the region to be detected. The solutions in the present disclosure are lightweight solutions that may not only improve the accuracy of object detection, but also increase the efficiency of object detection.

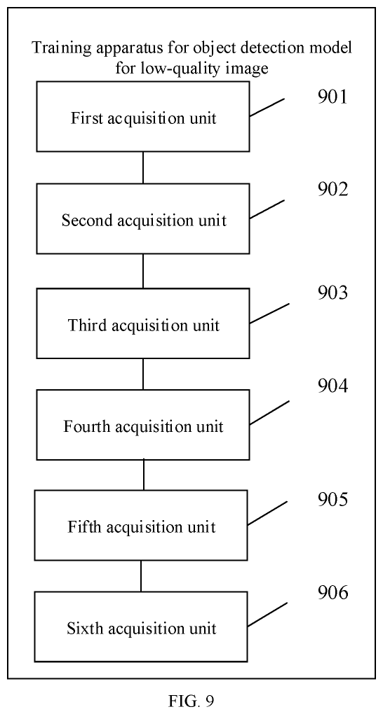

An embodiment of the present disclosure provides a training apparatus for an object detection model for a low-quality image, as shown in FIG. 9, the apparatus includes:
a first acquisition unit 901, used for acquiring a low-quality sample image for a target region;
a second acquisition unit 902, used for inputting the low-quality sample image into a first encoder to obtain an initial feature of the low-quality sample image;
a third acquisition unit 903, used for inputting the initial feature into a transfer convolutional network, and training the transfer convolutional network to obtain a target convolutional network based on a first target feature, wherein the first target feature is obtained based on the initial feature of the low-quality sample image, and a feature definition of the first target feature is higher than a feature definition of the initial feature;
a fourth acquisition unit 904, used for obtaining a second target feature for the low-quality sample image based on the target convolutional network;
a fifth acquisition unit 905, used for inputting the second target feature into a first detection head, and training the first detection head to obtain an object detection head, wherein the first detection head is obtained based on the first target feature; and
a sixth acquisition unit 906, used for obtaining an object detection model based on the first encoder, the target convolutional network and the object detection head, wherein the object detection model is used for performing object detection on a low-quality image to be detected.

In an optional solution, the third acquisition unit 903 is used for inputting the initial feature into the transfer convolutional network, and training the transfer convolutional network by using the first target feature as a feature constraint for an output of the transfer convolutional network to obtain the target convolutional network.

In an optional solution, the third acquisition unit 903 is used for inputting the initial feature of the low-quality sample image into a pre-trained image type prediction model to obtain a low-quality type of the low-quality sample image; and obtaining the first target feature for the low-quality sample image based on the low-quality type of the low-quality sample image.

In an optional solution, the third acquisition unit 903 is used for inputting the low-quality type of the low-quality sample image into a pre-trained content mapping network to obtain mapping encoding information for the low-quality type; inputting the mapping encoding information and the initial feature of the low-quality sample image into a first decoder to obtain a restored sample image, wherein a definition of the restored sample image is higher than the definition of the low-quality sample image; and based on the restored sample image, obtaining the first target feature for the low-quality sample image.

In an optional solution, the third acquisition unit 903 is used for inputting the restored sample image and the low-quality sample image into a second encoder to obtain the first target feature; and
the fifth acquisition unit 905 is used for inputting the first target feature into a second detection head to be trained, and training the second detection head to be trained to obtain the first detection head.

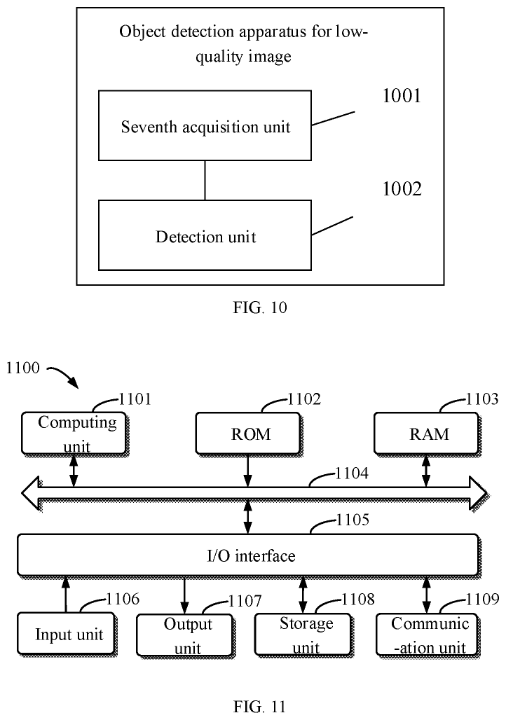

An embodiment of the present disclosure provides an object detection apparatus for a low-quality image, as shown in FIG. 10, the apparatus includes:
a seventh acquisition unit 1001, used for acquiring a low-quality image to be detected for a region to be detected; and
a detection unit 1002, used for inputting the low-quality image to be detected into an object detection model to obtain an object detection result for the region to be detected; wherein the object detection result is obtained by extracting a feature of the low-quality image to be detected by a first encoder in the object detection model, transferring the feature, which is extracted, by a target convolutional network in the object detection model, and performing object detection based on the feature, which is transferred, by an object detection head in the object detection model, and the object detection result is used for characterizing whether there is a target object in the region to be detected.

It should be noted that the training apparatus for the object detection model for the low-quality image and the object detection apparatus for the low-quality image in the embodiments of the present disclosure are similar to the aforementioned training method for the object detection model for the low-quality image and the aforementioned object detection method for the low-quality image in terms of principles of solving problems. Therefore, the implementation processes and principles as well as beneficial effects of the training apparatus for the object detection model for the low-quality image and the object detection apparatus for the low-quality image may be described with reference to the implementation processes and principles as well as beneficial effects of the aforementioned methods, and repetitions thereof are no longer elaborated.

According to an embodiment of the present disclosure, the present disclosure further provides an electronic device and a readable storage medium.

FIG. 11 shows a schematic block diagram of an exemplary electronic device 1100 that may be used for implementing the embodiments of the present disclosure. The electronic device is aimed at representing digital computers in various forms such as a laptop computer, a desktop computer, a workbench, a personal digital assistant, a server, a blade server, a mainframe computer, and other suitable computers. The electronic device may further represent mobile apparatuses in various forms such as a personal digital assistant, a cellular phone, a smartphone, a wearable device, and other similar computing apparatuses. The components, connections and relationships thereof and functions thereof shown herein are only exemplary, and are not intended to limit the implementation of the present disclosure described and/or claimed herein.

As shown in FIG. 11, the electronic device 1100 includes a computing unit 1101 that may perform various suitable actions and processing according to computer programs stored in a read-only memory (ROM) 1102 or computer programs loaded from a storage unit 1108 to a random access memory (RAM) 1103. In the RAM 1103, various programs and data required for operations of the electronic device 1100 are further stored. The computing unit 1101, the ROM 1102 and the RAM 1103 are connected to each other by a bus 1104. An input/output (I/O) interface 1105 is also connected to the bus 1104.

A plurality of components, including an input unit 1106 such as a keyboard, a mouse, and etc.; an output unit 1107 such as various types of displays, speakers, and etc.; a storage unit 1108 such as a magnetic disk, an optical disk; and a communication unit 1109 such as a network card, a modem, a wireless communication transceiver, and etc., in the electronic device 1100 are connected to the I/O interface 1105. The communication unit 1109 allows the electronic device 1100 to exchange information/data with other devices through computer networks such as the Internet and/or various telecommunication networks.

The computing unit 1101 may be various general-purpose and/or dedicated processing components with processing and computing capabilities. Some examples of the computing unit 1101 include, but are not limited to a central processing unit (CPU), a graphics processing unit (GPU), various dedicated artificial intelligence (AI) computing chips, various computing units that run machine learning model algorithms, a digital signal processor (DSP), and any suitable processors, controllers and microcontrollers. The computing unit 1101 performs each method and processing described above, such as the training method of the object detection model for the low-quality image and the object detection method of the low-quality image. For example, in some embodiments, the training method for the object detection model for the low-quality image and the object detection method for the low-quality image may be realized as computer software programs, and tangibly included in a machine-readable medium such as the storage unit 1108. In some embodiments, some or all of the computer programs may be loaded and/or installed onto the electronic device 1100 via the ROM 1102 and/or the communication unit 1109. When the computer programs are loaded onto the RAM 1103 and executed by the computing unit 1101, one or more steps of the training method for the object detection model for the low-quality image and the object detection method for the low-quality image that are described above, may be performed. Alternatively, in other embodiments, the computing unit 1101 may be configured to perform the training method for the object detection model for the low-quality image and the object detection method for the low-quality image in any other suitable manners (such as by means of firmware).

Various implementations of the systems and technologies described above herein may be realized in a digital electronic circuit system, an integrated circuit system, a field-programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. The various implementations may include: implementation in one or more computer programs, wherein the one or more computer programs may be executed and/or interpreted on a programmable system including at least one programmable processor, and the programmable processor may be a special-purpose or general-purpose programmable processor, may receive data and instructions from a storage system, at least one input apparatus, and at least one output apparatus, and may transmit the data and the instructions to the storage system, the at least one input apparatus, and the at least one output apparatus.

Program codes used for implementing the methods in the present disclosure may be written in any one or combination of a plurality of programming languages. The program codes may be provided to processors or controllers of general-purpose computers, special-purpose computers, or other programmable data processing apparatuses, such that the program codes, when executed by the processors or controllers, enable functions/operations specified in the process diagrams and/or block diagrams to be implemented. The program codes may be entirely executed on a machine, partially executed on a machine, partially executed as standalone software packages on a machine and partially executed as standalone software packages on a remote machine, or entirely executed on a remote machine or server.

In the context of the present disclosure, a machine-readable medium may be a tangible medium that may include or store programs used by or in combination with an instruction execution system, apparatus, or device. The machine-readable medium may be a machine-readable signal medium or machine-readable storage medium. The machine-readable medium may include, but is not limited to an electronic, magnetic, optical, electromagnetic, infrared, or semiconductor system, apparatus, or device, or any suitable combinations thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combinations thereof.

In order to provide interaction with a user, the systems and technologies described herein may be implemented on a computer, wherein the computer is provided with a display apparatus (such as a cathode ray tube (CRT) or liquid crystal display (LCD) monitor) for displaying information to the user; and a keyboard and a pointing apparatus (such as a mouse or trackball) by which the user may provide an input to the computer. Other types of apparatuses may also be used for providing interaction with a user; for example, feedback provided to the user may be sensory feedback in any form (such as visual feedback, auditory feedback, or tactile feedback); and an input from the user may be received in any form (including sound input, voice input, or tactile input).

The systems and technologies described herein may be implemented in a computing system including backend components (such as a data server), or a computing system including middleware components (such as an application server), a computing system including frontend components (such as a user computer with a graphical user interface or web browser through which users may interact with the implementation of the systems and technologies described herein), or a computing system including any combinations of the backend components, the middleware components, or the frontend components. The components of the system may be interconnected through digital data communication (such as a communication network) in any form or medium. Examples of the communication network include a local area network (LAN), a wide area network (WAN), and the Internet.

A computer system may include a client terminal and a server. The client terminal and the server are generally far from each other and usually interact through the communication network. A relationship between the client terminal and the server is generated by computer programs running on corresponding computers and being in the relationship between the client terminal and the server. The server may be a cloud server, a server of a distributed system, or a server integrated with a block chain.

It should be understood that processes shown above in various forms may be used to reorder, add, or delete steps. For example, all the steps described in the present disclosure may be performed concurrently, sequentially, or in different orders, which is not limited herein as long as desired results of the technical solutions disclosed in the present disclosure may be achieved.

In addition, terms “first” and “second” are only used for descriptive purposes and cannot be understood as indicating or implying relative importance or implicitly indicating the number of indicated technical features. Therefore, features limited to “first” and “second” may explicitly or implicitly include at least one of the features. In the description of the present disclosure, “a plurality of” refers to two or more unless otherwise specifically limited.

The specific implementations of the present disclosure are only shown as above, but the protective scope of the present disclosure is not limited to thereto. Any variations or substitutions that may be readily conceived by those skilled in the art within the technical scope disclosed by the present disclosure should fall within the protective scope of the present disclosure. Therefore, the protective scope of the present disclosure should be subject to the protective scope of the claims.

What is claimed is:

1. A training method for an object detection model for a low-quality image, comprising:
acquiring a low-quality sample image for a target region;
inputting the low-quality sample image into a first encoder to obtain an initial feature of the low-quality sample image;
inputting the initial feature into a transfer convolutional network, and training the transfer convolutional network to obtain a target convolutional network based on a first target feature, wherein the first target feature is obtained based on the initial feature of the low-quality sample image, and a feature definition of the first target feature is higher than a feature definition of the initial feature;
obtaining a second target feature for the low-quality sample image based on the target convolutional network;
inputting the second target feature into a first detection head, and training the first detection head to obtain an object detection head, wherein the first detection head is obtained based on the first target feature; and
obtaining the object detection model based on the first encoder, the target convolutional network and the object detection head, wherein the object detection model is configured for performing object detection on a low-quality image to be detected.

2. The training method according to claim 1, wherein the inputting the initial feature into the transfer convolutional network, and training the transfer convolutional network to obtain the target convolutional network based on the first target feature, comprises:
inputting the initial feature into the transfer convolutional network, and training the transfer convolutional network by using the first target feature as a feature constraint for an output of the transfer convolutional network to obtain the target convolutional network.

3. The training method according to claim 1, wherein obtaining the first target feature based on the initial feature of the low-quality sample image comprises:
inputting the initial feature of the low-quality sample image into a pre-trained image type prediction model to obtain a low-quality type of the low-quality sample image; and
obtaining the first target feature for the low-quality sample image based on the low-quality type of the low-quality sample image.

4. The training method according to claim 3, wherein the obtaining the first target feature for the low-quality sample image based on the low-quality type of the low-quality sample image, comprises:
inputting the low-quality type of the low-quality sample image into a pre-trained content mapping network to obtain mapping encoding information for the low-quality type;
inputting the mapping encoding information and the initial feature of the low-quality sample image into a first decoder to obtain a restored sample image, wherein a definition of the restored sample image is higher than a definition of the low-quality sample image; and
obtaining the first target feature for the low-quality sample image based on the restored sample image.

5. The training method according to claim 4, wherein
the obtaining the first target feature for the low-quality sample image based on the restored sample image, comprises:
inputting the restored sample image and the low-quality sample image into a second encoder to obtain the first target feature;
obtaining the first detection head based on the first target feature, comprises:
inputting the first target feature into a second detection head to be trained, and training the second detection head to be trained to obtain the first detection head.

6. An object detection method for a low-quality image, comprising:
acquiring a low-quality image to be detected for a region to be detected; and
inputting the low-quality image to be detected into an object detection model to obtain an object detection result for the region to be detected;
wherein the object detection result is obtained by:
extracting a feature of the low-quality image to be detected by a first encoder in the object detection model,
transferring the feature, wherein the feature is extracted, by a target convolutional network in the object detection model, and
performing object detection based on the feature, wherein the feature is transferred, by an object detection head in the object detection model; and
the object detection result is allowed for characterizing whether there is a target object in the region to be detected.

7. An apparatus for object detection processing of a low-quality image, wherein the training apparatus comprises:
a first acquisition unit, configured for acquiring a low-quality sample image for a target region;
a second acquisition unit, configured for inputting the low-quality sample image into a first encoder to obtain an initial feature of the low-quality sample image;
a third acquisition unit, configured for inputting the initial feature into a transfer convolutional network, and training the transfer convolutional network to obtain a target convolutional network based on a first target feature, wherein the first target feature is obtained based on the initial feature of the low-quality sample image, and a feature definition of the first target feature is higher than a feature definition of the initial feature;
a fourth acquisition unit, configured for obtaining a second target feature for the low-quality sample image based on the target convolutional network;
a fifth acquisition unit, configured for inputting the second target feature into a first detection head, and training the first detection head to obtain an object detection head, wherein the first detection head is obtained based on the first target feature;
a sixth acquisition unit, configured for obtaining the object detection model based on the first encoder, the target convolutional network and the object detection head;
a seventh acquisition unit, configured for acquiring a low-quality image to be detected for a region to be detected; and
an eighth unit, configured for inputting the low-quality image to be detected into the object detection model to obtain an object detection result for the region to be detected;
wherein the object detection result is obtained by:
extracting a feature of the low-quality image to be detected, by the first encoder in the object detection model,
transferring the feature obtained after extraction, by the target convolutional network in the object detection model, and
performing object detection based on the feature obtained after transferring, by the object detection head in the object detection model; and
wherein the object detection result is allowed for characterizing whether there is a target object in the region to be detected.

8. An electronic device, comprising:
at least one processor; and
a memory connected in communication with the at least one processor;
wherein the memory stores instructions executed by the at least one processor, and the instructions, upon being executed by the at least one processor, cause the at least one processor to perform the training method according to claim 1.

9. A non-transitory computer-readable storage medium having computer instructions stored thereon, wherein the computer instructions are allowed for enabling a computer to perform the training method according to claim 1.

10. The training method according to claim 2, wherein obtaining the first target feature based on the initial feature of the low-quality sample image comprises:
inputting the initial feature of the low-quality sample image into a pre-trained image type prediction model to obtain a low-quality type of the low-quality sample image; and
obtaining the first target feature for the low-quality sample image based on the low-quality type of the low-quality sample image.

11. An electronic device, comprising:
at least one processor; and
a memory connected in communication with the at least one processor;
wherein the memory stores instructions executed by the at least one processor, and the instructions, upon being executed by the at least one processor, cause the at least one processor to perform the object detection method according to claim 6.

12. A non-transitory computer-readable storage medium having computer instructions stored thereon, wherein the computer instructions are allowed for enabling a computer to perform the object detection method according to claim 6.

13. The electronic device according to claim 8, wherein in the training method, the inputting the initial feature into the transfer convolutional network, and training the transfer convolutional network to obtain the target convolutional network based on the first target feature, comprises:
inputting the initial feature into the transfer convolutional network, and training the transfer convolutional network by using the first target feature as a feature constraint for an output of the transfer convolutional network to obtain the target convolutional network.

14. The electronic device according to claim 8, wherein in the training method, obtaining the first target feature based on the initial feature of the low-quality sample image comprises:
inputting the initial feature of the low-quality sample image into a pre-trained image type prediction model to obtain a low-quality type of the low-quality sample image; and
obtaining the first target feature for the low-quality sample image based on the low-quality type of the low-quality sample image.

15. The electronic device according to claim 14, wherein in the training method, the obtaining the first target feature for the low-quality sample image based on the low-quality type of the low-quality sample image, comprises:
inputting the low-quality type of the low-quality sample image into a pre-trained content mapping network to obtain mapping encoding information for the low-quality type;
inputting the mapping encoding information and the initial feature of the low-quality sample image into a first decoder to obtain a restored sample image, wherein a definition of the restored sample image is higher than a definition of the low-quality sample image; and
obtaining the first target feature for the low-quality sample image based on the restored sample image.

16. The electronic device according to claim 15, wherein in the training method, the obtaining the first target feature for the low-quality sample image based on the restored sample image, comprises:
inputting the restored sample image and the low-quality sample image into a second encoder to obtain the first target feature;
obtaining the first detection head based on the first target feature, comprises:
inputting the first target feature into a second detection head to be trained, and training the second detection head to be trained to obtain the first detection head.

17. The non-transitory computer-readable storage medium according to claim 9, wherein in the training method, the inputting the initial feature into the transfer convolutional network, and training the transfer convolutional network to obtain the target convolutional network based on the first target feature, comprises:
inputting the initial feature into the transfer convolutional network, and training the transfer convolutional network by using the first target feature as a feature constraint for an output of the transfer convolutional network to obtain the target convolutional network.

18. The non-transitory computer-readable storage medium according to claim 9, wherein in the training method, obtaining the first target feature based on the initial feature of the low-quality sample image comprises:
inputting the initial feature of the low-quality sample image into a pre-trained image type prediction model to obtain a low-quality type of the low-quality sample image; and
obtaining the first target feature for the low-quality sample image based on the low-quality type of the low-quality sample image.

19. The non-transitory computer-readable storage medium according to claim 18, wherein in the training method, the obtaining the first target feature for the low-quality sample image based on the low-quality type of the low-quality sample image, comprises:
inputting the low-quality type of the low-quality sample image into a pre-trained content mapping network to obtain mapping encoding information for the low-quality type;
inputting the mapping encoding information and the initial feature of the low-quality sample image into a first decoder to obtain a restored sample image, wherein a definition of the restored sample image is higher than a definition of the low-quality sample image; and
obtaining the first target feature for the low-quality sample image based on the restored sample image.

20. The non-transitory computer-readable storage medium according to claim 19, wherein in the training method, the obtaining the first target feature for the low-quality sample image based on the restored sample image, comprises:
inputting the restored sample image and the low-quality sample image into a second encoder to obtain the first target feature;
obtaining the first detection head based on the first target feature, comprises:
inputting the first target feature into a second detection head to be trained, and training the second detection head to be trained to obtain the first detection head.
